(19) United States
(12) Patent Application Publication
(10) Pub. No.: US 2008/0094735 A1
(43) Pub. Date: Apr. 24, 2008

(54) Portable Device Magnification Assembly

(76) Inventor: Robert T. Chelberg, Prague (CZ)

Correspondence Address: FROST BROWN TODD, LLC, 2200 PNC CENTER, 201 E. FIFTH STREET, CINCINNATI, OH, 45202, US

(21) Appl. No.: 11/552,251

(22) Filed: Oct. 24, 2006

(51) Int. Cl. G02B 27/02

(52) U.S. Cl. 359/802

(57) ABSTRACT

Disclosed is a magnification assembly configured to assist users of portable devices in reading user interface features such as a display or a keypad. Versions of the magnification assembly include a retainer having an attachment surface and an aperture, wherein the retainer is operably configured to receive a magnifying member. The retainer may be adhesively coupled to the portable device with the attachment surface.

### FIELD OF THE INVENTION

The present invention relates, in general, to portable devices, and, in particular, to a magnification assembly for portable devices.

### BACKGROUND OF THE INVENTION

Portable devices have become increasingly popular over the past decade. In addition to becoming more numerous, in part due to advances in semiconductor and circuitry technology, the size of these portable devices has substantially decreased over that same time period. Consequently, the user interface features of portable devices, such as the keypads and displays, have also become more compact. This reduction in size frequently makes reading information displayed on user interface features of such devices more difficult. The diminutive nature of these displays and keypads may result in user error and a loss of efficiency that may negate any positive benefits associated with the portable device's small size.

Numerous magnification devices have been developed to assist users in reading the displays or keypads of portable devices. Frequently, these devices are constructed integrally with the portable device itself. One example of such an integral magnification device is South Korean Patent No. 2003019534 to Lee. The relatively permanent nature of integral magnification devices often eliminates the flexibility to remove the magnification device from the portable device if the magnification device is not needed by the user. Additionally, present day consumers frequently prefer interchangeable or selectable accessories for portable devices that suit their lifestyle. Relatively permanent integral magnification systems may be overly restrictive.

Alternate magnification devices have been developed that may be coupled to the display of a portable device. Examples of this type of magnification device include U.S. Pat. No. 6,795,256 to Wang, U.S. Pat. No. 6,067,459 to Lincoln, et al., WO 02/091338 to Motohashi, German Patent No. 10058727 to Kroemer, et al., and Japanese Patent No. 2004-015605 to Totani. These magnification devices may be cumbersome additions to the portable device, making the portable device bulky and awkward for the user to transport in hand or in a pocket. Additionally, the magnification device may be fixed to a position above the display, and, therefore, the user may not be able to magnify any other user interface feature, such as the keypad. For example, in U.S. Pat. No. 6,985,311 to Bartone, the magnification device is secured to the top portion of the phone above the display and may not be adjusted to magnify the keypad. Magnification devices coupled to the display may be overly restrictive in that they require a user to view the display in the magnified configuration at all times.

Another type of magnification device has been developed that may be attached to the portable device with a sleeve. Examples of this type of device include U.S. Pat. No. 6,275,333 to Shaffer, U.S. Pat. No. 6,151,172 to Ferraro, and Japanese Patent No. 2003-18270 to Takahashi. Similar to the magnification devices coupled to the display, these devices may be cumbersome when attached to the portable device. Such devices may be operably configured such that when the sleeve magnification device is attached to the portable device the user may only view the portable device in a magnified state. If the user desires to view an un-magnified portable device, the sleeve magnification device must be completely removed from the portable device, which may make the sleeve magnification device cumbersome and prone to loss.

It would be advantageous to provide an assembly that magnifies the user interface features of a portable device to improve readability and operability. In addition, it would be advantageous to provide such an assembly that may be produced cost effectively. It would be advantageous to provide an assembly that eliminates searching for a magnification device when magnification is desired. It would be advantageous to provide an assembly which can magnify multiple aspects on the portable device. It would be advantageous to provide an assembly which may be easily stored by the user. It would be advantageous to provide an assembly which allows the user to view the portable device in either an un-magnified state or a magnified state depending on the needs of the user at the time of operation.

### BRIEF SUMMARY OF THE INVENTION

Provided is a magnification assembly that may be configured to magnify a user interface feature, such as a display and/or a keypad, contained on a first surface of a portable device. In one version, the magnification assembly includes a magnifying member and a retainer attached to a second surface of the portable device. The magnifying member may include a magnifying lens operably configured to magnify user interface features. The magnifying member may be stored in the retainer while not in use. In an alternate version, the magnification assembly includes a magnifying member and a retainer attached to a portable device container. In an alternate version, the portable device and the magnifying member may be attached to a personal attachment system. The personal attachment system may include a user attachment lanyard, a junction member, a portable device connection member and an accessory connection member. The user attachment lanyard may be configured as a loop for placement about a user with a junction member attached to it. The portable device connection member and the accessory connection member may be configured to couple the portable device and the magnifying member, respectively, to the user attachment lanyard.

### BRIEF DESCRIPTION OF THE DRAWINGS

The accompanying drawings incorporated in and forming a part of the specification illustrate several aspects of the present invention, and together with the description, serve to explain the principles of the invention; it being understood, however, that this invention is not limited to the precise arrangements shown. In the drawings, like reference numerals refer to like elements in the several views. In the drawings:

FIG. 1A is a perspective environmental front view of one version of a portable device shown with a retainer attached to a back face thereof, the retainer having a magnifying member stored therein.

FIG. 1B is a perspective environmental rear view of one version of the portable device illustrated in FIG. 1A shown with the retainer attached to the back face thereof, the retainer having the magnifying member stored therein.

FIG. 2 is a perspective view of the magnifying member illustrated in FIG. 1B shown retained within the retainer.

FIG. 3 is a perspective view of the magnifying member illustrated in FIG. 1B shown removed from the retainer.

FIG. 4 is an environmental front view of the magnifying member illustrated in FIG. 1B shown magnifying a display of the portable device.

FIG. 5 is a perspective environmental rear view of one version of a portable device shown with a retainer having a magnifying member stored therein, where the magnifying member is attached to the portable device with a lanyard.

FIG. 6 is a perspective rear view of one version of a portable device shown with a retainer having a magnifying member stored therein, where the magnifying member is attached to the portable device with a lanyard and a clip.

FIG. 7 is an environmental front view of one version of a retainer attached to a portable device container.

FIG. 8 is an environmental perspective rear view of one version of a portable device shown with a magnifying member attached to the portable device with a lanyard.

FIG. 9 is an environmental perspective view of one version of a portable device shown with a personal attachment system attached to the portable device and a magnifying member attached to the personal attachment system.

### DETAILED DESCRIPTION OF THE INVENTION

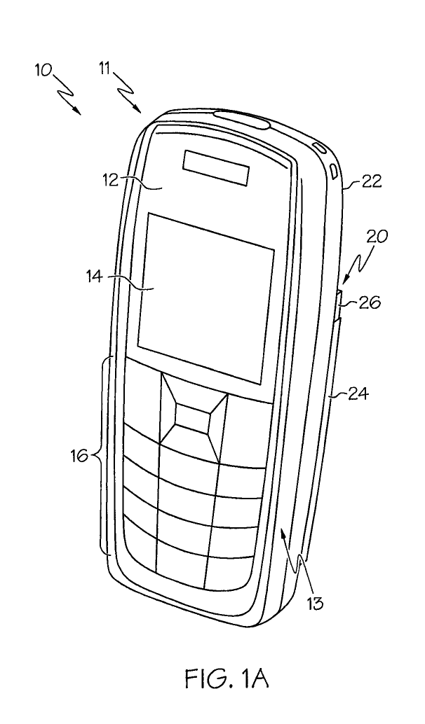

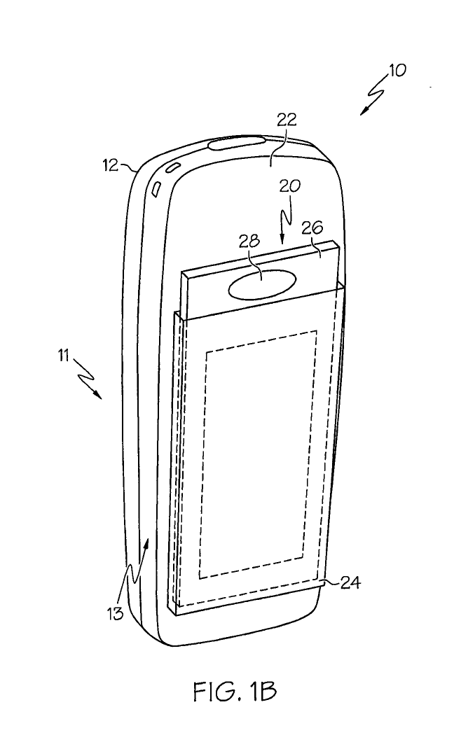

FIGS. 1A-1B show a portable device magnification assembly 10, which includes a portable device 11 and a magnification assembly 20. FIGS. 1A-1B illustrate one version of a magnification assembly 20 that enables users to magnify user interface features, such as a display 14 and a keypad 16, on a portable device 11. The portable device 11 may be a mobile phone, or any other suitable device for which magnification may improve the readability of the user interface features or operability of the device. For example, magnification of the interface features, such as the display 14 and keypad 16, of the portable device 111 may make the interface features easier to read and/or easier to operate, thereby reducing operator error.

Versions of the magnification assembly 20 may achieve economy of production due to the simple design of the magnification assembly 20. The magnification assembly may be attached to the portable device 11 to increase portability and eliminate the need to search for the magnification assembly 20 when magnification is desired. Attachment to the portable device 11 may allow for magnification of the user interface features wherever and whenever desired by the user. In one version, the magnification assembly 20 is operably configured to allow the user to select which user interface feature to magnify, depending on the needs of the user at the time of operation. The magnification assembly 20 may be configured such that it may be accessed as needed by the user and re-stored when magnification is not desirable. The magnification assembly 20 may provide an affordable, portable, removable, easy-to-find, and easy-to-use assembly to enhance the usability of any portable device.

FIG. 1A shows one version of the portable device 11, which includes a housing 13 having a first surface and a second surface. In the illustrated version, the first surface is a front face 12 and the second surface is a back face 22. It will be appreciated that the front face 12 and the back face 22 are listed by way of example only and that the user interface feature may be associated with any suitable face and/or surface. The front face 12 may include at least one user interface feature, such as the display 14 and/or the keypad 16. As used herein, the term user interface feature refers to a component of a portable device configured for operation, display, transmission, data entry, input, or for any other suitable purpose.

In one version, the user interface feature comprises a display, such as, for example, a light-emitting diode (LED) display, a liquid crystal display (LCD), a plasma display, or any other type of display capable of presenting data thereon. In an alternate version, the user interface feature comprises a keypad, such as a navigation keypad, an alphanumeric keypad, a numeric keypad, a QWERTY keypad, a QWERTZ keypad, an AZERTY keypad, or any other suitable type of data entry component or device. In the illustrated version, the display 14 is operably configured to present data, such as phone numbers, names, and menu options, for a user to view. The keypad 16 may be operably configured to allow the user to operate the portable device 11 where, for example, the keypad 16 may be operably configured to allow the user to input information into the portable device 11. In an alternate version, the keypad 16 may be operably configured to allow the user to navigate various menu options presented on the display 14. Referring to FIGS. 1A-1B, in the illustrated version, the portable device 11 is a mobile telephone. It will be appreciated that the portable device 11 may be any suitable device for which magnification is desirable including, but not limited to, a mobile telephone, a cordless telephone handset, a clamshell mobile telephone, a slider mobile telephone, a portable media player, a portable audio player, a portable video player, a digital audio player, an external data storage device, a handheld game console, a calculator, a personal digital assistant, a radio, a handheld television, a smartphone, a paging device, a handheld global positioning system device, a portable display module, a portable visual display device, a two-way communication device, a one-way communication device, a handheld computing device, a handheld information appliance, a handheld internet appliance, a handheld personal communicator, and combinations thereof.

In one version, the magnification assembly 20 includes a magnifying member 26 retained within a retainer 24, where the retainer 24 is attached to the back face 22 of the portable device 11. The retainer 24 may be attached to the back face 22 with an adhesive, a strip of adhesive, a hook and loop fastener, a strip of double sided tape, a suction device, or with any other suitable method or device. The retainer 24 may be attached to the back face 22 such that the user may detach and re-attach the retainer 24 as desired. The retainer 24 may be dimensioned such that it does not protrude beyond or substantially beyond the outer perimeter of the portable device 11. The size and shape of the retainer 24 may be configured to minimize interference with the operation, storage, and function of the portable device 11. The retainer 24 may be comprised of thin, flexible plastic or any other suitable material. It will be appreciated that the attachment of the retainer to the back face is shown by way of example, and the retainer may be associated with, for example, a side face, an inner face of a clamshell type mobile phone, or any other suitable face and/or surface. It will be appreciated that the retainer and a user interface feature may be associated with the same surface.

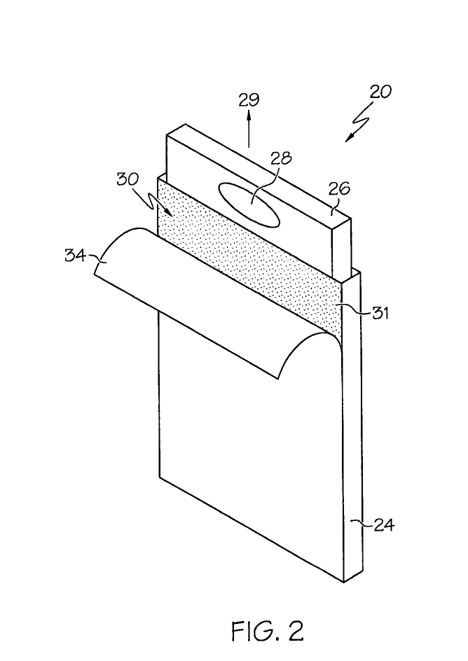

As shown in FIG. 2, the retainer 24 includes an attachment surface 30. In the illustrated version, an adhesive 31 is applied substantially coextensively to the attachment surface 30. The retainer 24 includes a removable member 34 that substantially covers the adhesive 31 such that the adhesive 31 is not exposed until the removable member 34 is detached. The adhesive 31 may be agglutinative, so as to secure the retainer 24 to the back face 22 when attached. Alternatively, the retainer 24 may be attached to the back face 22 with a strip of adhesive, a strip of double-sided tape, a hook and loop fastener, a suction device, or any other suitable method or device. In the illustrated version, when the retainer 24 is attached to the portable device 11, the attachment surface 30 is coupled with the back face 22 of the portable device 11. In an alternate version, the adhesive 31 and removable member 34 may be included on the back face 22 of the portable device 11.

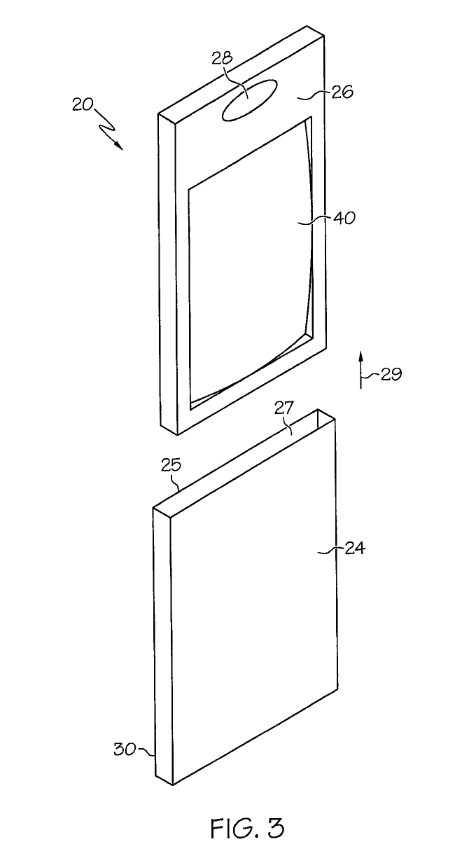

In the version shown in FIGS. 1B-2, a magnifying member 26 is stored at least partially within the retainer 24. In the illustrated version, the magnifying member 26 includes an insertion tab 28, which may be grasped by the user when handling the magnifying member 26. As shown in FIGS. 2-3, the magnifying member 26 may be removed from the retainer 24 by grasping the insertion tab 28 and pulling in a generally vertical direction, as indicated by the arrow 29. The configuration of the retainer 24 and the magnifying member 26, and the attachment of the retainer 24 to the portable device 11 provide portability and eliminate the need to search for the magnifying member 26 when magnification is desired.

In the illustrated version, the retainer 24 comprises a sheath having an aperture 27 operably configured to removably and slidingly receive the magnifying member 26. As shown in FIG. 3, the magnifying member 26 may be removed from the retainer 24. In the illustrated version, the aperture 27 is located along the top edge 25 of the retainer 24. However, in alternate versions, the aperture 27 may be located along any of the various edges of the retainer 24 in order to optimize the user's ability to quickly and easily slide the magnifying member into and out of the retainer 24. In the illustrated version, the aperture 27 allows the magnifying member 26 to be stored in the retainer 24, which provides both protection and portability for the magnifying member 26. In an alternate version, the retainer may include two apertures positioned on opposing edges of the retainer to allow the user to select the most convenient point of insertion or removal of the magnifying member.

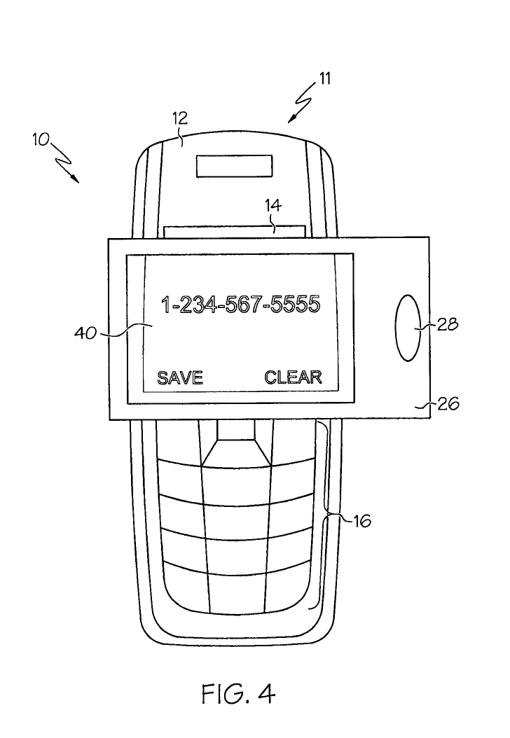

The magnifying member 26 may be substantially rectangular, substantially circular, substantially square, or any other suitable shape. The shape may correspond to the particular portable device 11 selected by the user. As shown in FIGS. 3-4, the magnifying member 26 includes a magnifying lens 40 made of plastic or any other suitable material capable of magnification. The magnifying lens 40 may be selected from the group consisting of a convex lens, a plano-convex lens, a concave-convex lens, a meniscus lens, a plano-concave lens, a concave lens, a flat lens, and any other suitable type of lens. The magnifying lens 40 may be a Fresnel lens having stepped setbacks so as to have the optical properties of a much thicker lens. The magnification strength of the magnification lens may vary from lens to lens, thereby providing a user with a choice of lenses based on the user's needs and the type of portable device selected by the user.

The magnifying lens 40 may be positioned over any portion of the portable device 11, including the user interface features, such as the display 14 and the keypad 16, associated with the front face 12 of the portable device 11. For example, the magnifying lens 40 may be positioned over the display 14, as shown in FIG. 4, to magnify the data presented on the display 14. The magnifying lens 40 may also be positioned over the keypad 16 to magnify the letters, numbers, or symbols printed thereon. It will be appreciated that magnifying the display 14 and the keypad 16 may enhance the ease of use of the portable device 11 and may reduce errors in reading or operating the portable device 11.

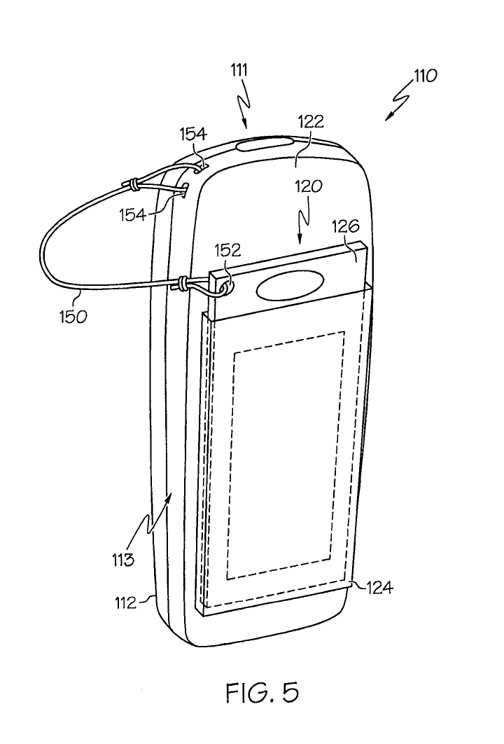

FIG. 5 shows an alternate version of a portable device magnification assembly 110, which includes a portable device 111 and a magnification assembly 120. The portable device 111 includes a housing 113 having a front face 112 and a back face 122. The front face 112 may include at least one user interface feature, such as a display, such as, for example, the display 14 of FIG. 1A, and/or a keypad, such as, for example, the keypad 16 of FIG. 1A. In the illustrated version, the magnification assembly 120 includes a retainer 124 attached to the back face 122, in which a magnifying member 126 is stored. In the illustrated version, the magnifying member 126 is attached to the portable device 111 with a lanyard 150. The lanyard 150 may prevent the magnifying member 126 from being separated from the portable device 111, thereby allowing the user to easily locate and use the magnifying member 126 when desired. In one version, the lanyard 150 is of sufficient length to allow the user to move the magnifying member 126 from a storage position in the retainer 124 to the front face 112 of the portable device 111 to be used. The lanyard 150 may, for example, be attached at one end to the magnifying member 126, and at the other end to the portable device 111. The lanyard 150 may be attached to the magnifying member 126 by looping the lanyard 150 through an attachment aperture 152 in the magnifying member 126 and tying the lanyard 150 in a knot. The lanyard 150 may be attached to the portable device 111 by looping the lanyard 150 through an attachment aperture 154 in the portable device 111 and tying the lanyard 150 in a knot. In addition to the attachment of the retainer 124 to the portable device 111, attaching the magnifying member 126 to the portable device 111 with a lanyard 150 may ensure that the magnifying member 126 can be easily located by the user when magnification is desired. The lanyard 150 may comprise string, fabric, rubber, cloth, or any other suitable material.

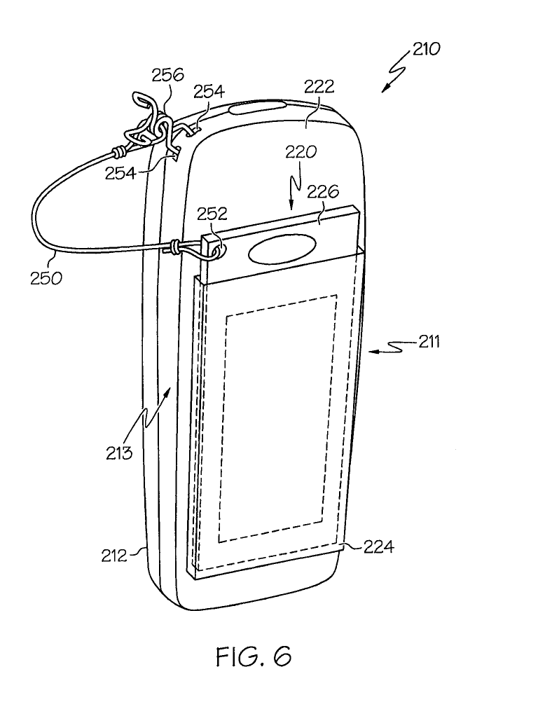

FIG. 6 shows an alternate version of a portable device magnification assembly 210, which includes a portable device 211 and a magnification assembly 220. The portable device 211 includes a housing 213 having a front face 212 and a back face 222. The front face 212 may include at least one user interface feature, such as a display, such as, for example, the display 14 of FIG. 1A and/or a keypad, such as, for example, the keypad 16 of FIG. 1 A. In the illustrated version, the magnification assembly 220 includes a retainer 224 attached to the back face 222 in which a magnifying member 226 is retained. In the illustrated version, the magnifying member 226 is attached to the portable device 211 with a lanyard 250 having a clip 256. The lanyard 250 may, for example, be attached at one end to the magnifying member 226 and at the other end to the portable device 211 with the clip 256. The lanyard 250 may be attached to the magnifying member 226 by looping the lanyard 250 through an attachment aperture 252 in the magnifying member 226 and tying the lanyard 250 in a knot. The clip 256 may be operably configured to engage an attachment aperture 254 in the portable device 211 to removably attach the magnifying member 226 thereto. In an alternate version, the clip 256 may be operably configured to removably attach to any suitable portion of the portable device 211. In an alternate version, the lanyard 250 may include a clip 256 operably configured to attach the lanyard 250 to the magnifying member 226. The clip 256 may provide additional flexibility, allowing the user to detach the magnifying member 226 from the portable device 211 if desired. In this manner, for example, a single magnifying member may be used with multiple portable devices.

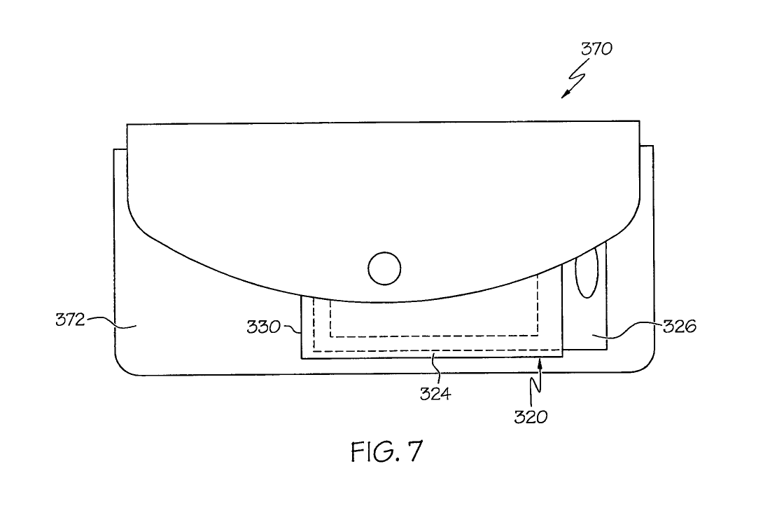

FIG. 7 illustrates an alternate version of a magnification assembly 320 shown attached to a portable device container 370 having an outer surface 372. The portable device container 370 may be operably configured to secure or retain a portable device for protection, transport, or the like. The portable device container 370 may protect the portable device when the portable device is being operated by the user or when the portable device is being stored by the user. In the illustrated version, the magnification assembly 320 includes a retainer 324 and a magnifying member 326 retained therein. The retainer 324 may be positioned such that an attachment surface 330 of the retainer 324 is coupled with the outer surface 372. In an alternate version, the retainer 324 may be positioned such that the attachment surface 330 of the retainer 324 is coupled with an inner surface of the portable device container 370, provided the retainer 324 does not interfere with the function or storage of the portable device container 370. The user may desire to attach the retainer 324 to an inner surface of the portable device container 370 in order to preserve the aesthetic appearance of the outer surface 372 of the portable device container 370.

The retainer 324 may be dimensioned or configured such that it does not protrude beyond or substantially beyond the outer perimeter of the portable device container 370. The size and shape of the retainer 324 may be altered to minimize interference with the function of the portable device container 370. The magnifying member 326 may be removed from the retainer 324 when the user is operating a portable device in order to magnify a portion of the portable device. The size and shape of the portable device container 370 may correspond to the particular portable device selected by the user. The retainer 324 may be attached to the portable device container 370 with an adhesive, a strip of adhesive, a strip of double-sided tape, a hook and loop fastener, a clip, a suction device, or any other suitable method or device.

The retainer may be configured for attachment to both a portable device and the container associated with the portable device, allowing the user to choose where to attach the retainer. For example, the retainer may be associated with a cell phone and/or a cell phone case. The retainer may be removably attached upon initial application by the user, thereby enabling the user to transfer the retainer between the portable device and the portable device container multiple times. This transferability may provide further flexibility for the user, by allowing the user to select whether the retainer is attached to the portable device or to the portable device container.

In an alternate version, the magnifying member 326 may be attached to the portable device container 370 with a lanyard, such as, for example, the lanyard 150 illustrated in FIG. 5. In addition to the attachment of the retainer 324 to the portable device container 370, attaching the magnifying member 326 to the portable device container 370 with a lanyard may further ensure that the magnifying member 326 is easily locatable. The lanyard may include a clip, such as the clip 256 illustrated in FIG. 6, operably configured to attach the lanyard to the portable device container. In an alternate version, the lanyard may include a clip operably configured to attach the lanyard to the magnifying member 326. The clip may provide additional flexibility by allowing the user to detach the magnifying member 326 from the portable device container 370 if desired. In this manner, for example, a single magnifying member may be used with multiple portable devices or portable device containers.

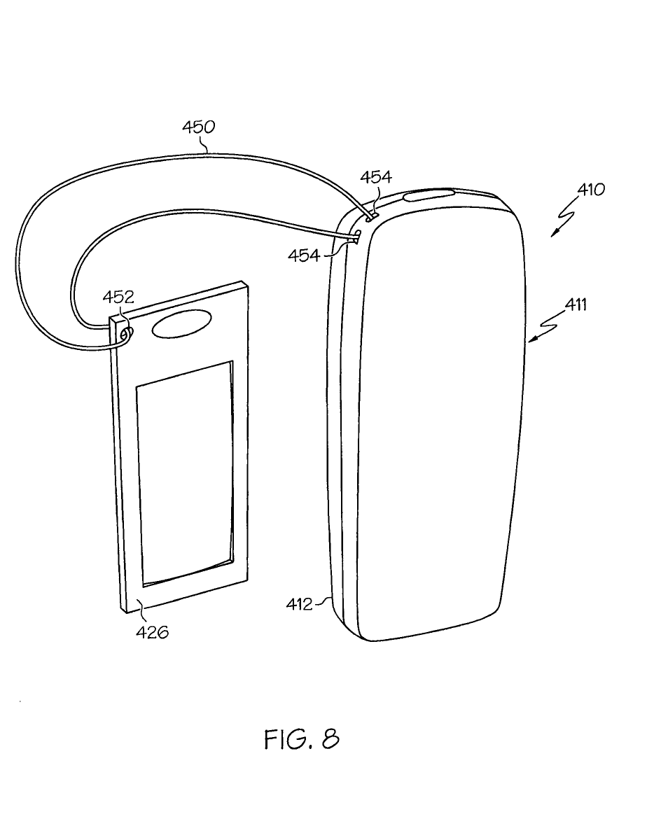

FIG. 8 shows an alternate version of a portable device magnification assembly 410 with a magnifying member 426 attached to a portable device 411 with a lanyard 450. The lanyard 450 may prevent the magnifying member 426 from being separated from the portable device 411 when, for example, the magnifying member 426 is not in use. In one version, the lanyard 450 is of sufficient length to allow the user to move the magnifying member 426 to a front face 412 of the portable device 411 for use. The lanyard 450 may be attached at one end to the magnifying member 426 and at the other end to the portable device 411.

When the magnifying member 426 is not in use it may be suspended from the lanyard 450 adjacent to the portable device 411. This may avoid interference with the operation, storage and function of the portable device 411 while providing easy access to the magnifying member 426. The lanyard 450 may be configured as a continuous loop, as shown in FIG. 8, or may be configured to attach to the portable device 411 and the magnifying member 426 at opposing ends of the lanyard 450, as shown in FIG. 5. The lanyard 450 may be attached to the magnifying member 426 by looping the lanyard 450 through an attachment aperture 452 in the magnifying member 426. The lanyard 450 may be attached to the portable device 411 by looping the lanyard through an attachment aperture 454 in the portable device 411.

The lanyard 450 may include a clip, such as the clip 256 illustrated in FIG. 6, operably configured to attach the lanyard 450 to the portable device 411 by engaging the attachment aperture 454. The clip may be operably configured to attach the lanyard 450 to any suitable portion of the portable device 411. In an alternate version, the lanyard 450 may include a clip operably configured to attach the lanyard 450 to the magnifying member 426. The clip may provide additional flexibility by allowing the user to detach the magnifying member 426 from the portable device 411 if necessary. In this manner, for example, a single magnifying member may be used with multiple portable devices.

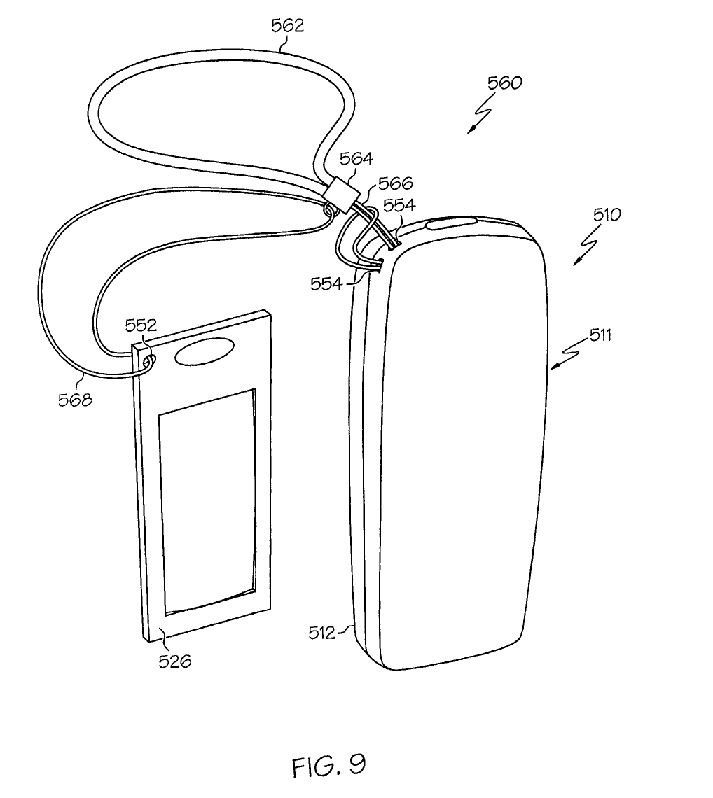

FIG. 9 shows an alternate version of a portable device magnification assembly 510 with a personal attachment system 560 coupled to a portable device 511. In the illustrated version, the personal attachment system 560 includes a user attachment lanyard 562, a junction member 564, a portable device connection member 566 and an accessory connection member 568. The user attachment lanyard 562 may be of sufficient size to allow the user to slip the user attachment lanyard 562 around the user's wrist or neck. In the illustrated version, the portable device connection member 566 is attached at one end to the junction member 564 and at the other end to the portable device 511. The portable device connection member 566 is attached to the portable device 511 by looping the portable device connection member 566 through an attachment aperture 554 in the portable device 511. The user attachment lanyard 562 may be configured to allow the user to transport the portable device 511 without holding the portable device 511 in the user's hand or storing the portable device 511 elsewhere on the user's person, thereby increasing the portability of the portable device 511.

In the version shown in FIG. 9, the personal attachment system 560 is also coupled with a magnifying member 526. In the illustrated version, the accessory connection member 568 is attached at one end to the junction member 564 and at the other end to the magnifying member 526. The accessory connection member 568 is attached to the magnifying member 526 by looping the connection member 566 through an attachment aperture 552 in the magnifying member 526. In one version, the accessory connection member 568 is of sufficient length to allow the user to move the magnifying member 526 to a front face 512 of the portable device 511 for use. Connecting the magnifying member 526 to the lanyard 560 may prevent the magnifying member 526 from being separated from the portable device 511 when, for example, the magnifying member 526 is not in use.

When the magnifying member 526 is not in use it may be suspended from the junction member 564 adjacent to the portable device 511. This may avoid interference with the operation, storage and function of the portable device 511, while providing easy access to the magnifying member 526. In an alternate version, when not in use, the magnifying member may be stored in a retainer attached to a surface of the portable device, such as, for example the retainer 24 shown in FIG. 1B. The portable device connection member 566 may be configured as a continuous loop, as shown in FIG. 9, or may be configured to attach to the junction member 564 and the portable device 511 at opposing ends of the portable device connection member 566, similar to the lanyard 150 shown in FIG. 5. The accessory connection member 568 may be configured as a continuous loop, as shown in FIG. 9, or may be configured to attach to the junction member 564 and the magnifying member 526 at opposing ends of the accessory connection member 568, similar to the lanyard 150 shown in FIG. 5.

The portable device connection member 566 may include a clip, such as the clip 256 illustrated in FIG. 6, operably configured to attach the portable device connection member 566 to the portable device 511 by engaging the attachment aperture 554 in the portable device 511. The clip may be operably configured to attach the portable device connection member to any suitable portion of the portable device 511. In an alternate version, the accessory connection member 568 may include a clip operably configured to attach the accessory connection member 568 to the magnifying member 526. The clip may provide additional flexibility by allowing the user to detach the magnifying member 526 from the portable device 511 if necessary. In this manner, for example, a single magnifying member may be used with multiple portable devices.

In summary, numerous benefits have been described which result from employing concepts of the invention. The foregoing description of one or more versions of the invention has been presented for purposes of illustration and description. It is not intended to be exhaustive or to limit the invention to the precise form disclosed. Obvious modifications or variations are possible in light of the above teachings. The one or more versions were chosen and described in order to best illustrate principles of the invention and its practical application to thereby enable one of ordinary skill in the art to utilize the invention in various versions and with various modifications as are suited to the particular use contemplated. It is intended that the scope of the invention be defined by the claims appended hereto.

What is claimed is:

1. A portable device magnification assembly comprising;
a. a portable device, the portable device comprising;
i. a first surface;
ii. a second surface; and
iii. a user interface feature associated with the first surface; and
b. a magnification assembly, the magnification assembly comprising:
i. a magnifying member, the magnifying member comprising a magnifying lens, wherein the magnifying lens is operably configured to magnify the user interface feature of the portable device; and
ii. a retainer, the retainer comprising;
(1) a sheath having an aperture, the aperture operably configured to receive the magnifying member for retention within the sheath; and
(2) an attachment surface, the attachment surface operably configured to associate the retainer with the second surface of the portable device, wherein the attachment surface is detachable from the second surface of the portable device such that the retainer may be removed.

2. The assembly of claim 1, wherein the user interface feature is a display operably configured to present data.

3. The assembly of claim 2, wherein the display is selected from the group consisting of a light emitting diode display, a liquid crystal display, a plasma display, and combinations thereof.

4. The assembly of claim 1, wherein the user interface feature is a keypad.

5. The assembly of claim 4, wherein the keypad is selected from the group consisting of a navigation keypad, an alphanumeric keypad, a numeric keypad, a QWERTY keypad, a QWERTZ keypad, an AZERTY keypad, any other suitable keypad, and combinations thereof.

6. The assembly of claim 1, wherein the first surface is a front face and the second surface is a back face.

7. The assembly of claim 1, wherein the magnifying lens is plastic.

8. The assembly of claim 1, wherein the lens is selected from the group consisting of a convex lens, a plano-convex lens, a concave-convex lens, a meniscus lens, a plano-concave lens, a concave lens, a flat lens, a Fresnel lens and combinations thereof.

9. The assembly of claim 1, wherein the retainer is dimensioned to attach substantially within the outer perimeter of the back surface of the portable device.

10. The assembly of claim 1, wherein the retainer is coupled to the portable device with an adhesive.

11. The assembly of claim 10, wherein the adhesive is covered by a removable member, where detaching the removable member exposes the adhesive.

12. The assembly of claim 10, wherein the adhesive is a hook and loop fastener.

13. The assembly of claim 10, wherein the adhesive is double-sided tape.

14. The assembly of claim 1, wherein the retainer is associated with the portable device with a suction device.

15. The assembly of claim 1, further comprising a lanyard, wherein the lanyard attaches the portable display device to the magnifying member.

16. The assembly of claim 15, further comprising a clip, wherein the clip removably attaches the lanyard to the portable display device.

17. The assembly of claim 15, further comprising a clip, wherein the clip removably attaches the lanyard to the magnifying member.

18. A portable device magnification assembly comprising:
a. a portable device container, the portable device container operably configured to hold a portable device having a user interface feature;
b. a magnifying member, the magnifying member comprising a magnifying lens, wherein the magnifying lens is operably configured to magnify the user interface feature of the portable device; and
c. a retainer, the retainer comprising;
i. a sheath having an aperture, the aperture operably configured to receive the magnifying member for retention within the sheath; and
ii. an attachment surface, the attachment surface operably configured to associate the retainer with the portable device container, wherein the attachment surface is detachable from the portable device container such that the retainer may be removed.

19. A portable device magnification assembly comprising:
a. a portable device, the portable device comprising;
i. a first surface;
ii. a second surface; and
iii. a user interface feature associated with the first surface;
b. a magnifying member, the magnifying member comprising a magnifying lens, wherein the magnifying lens is operably configured to magnify the user interface feature of the portable device; and
c. a personal attachment system, the personal attachment system comprising;
i. a user attachment lanyard, wherein the user attachment lanyard is configured as a loop from a substantially flexible material for placement about a user;
ii. a junction member, the junction member configured for attachment to the user attachment lanyard;
iii. a portable device connection member, the portable device connection member operably configured to couple the junction member with the portable device such that the portable device is securely connected to the user via the junction member and the user attachment lanyard; and
iv. an accessory connection member, the accessory connection member operably configured to couple the magnifying member with the personal attachment system.

20. The assembly of claim 19, further comprising a retainer, the retainer comprising;
a. a sheath having an aperture, the aperture operably configured to receive the magnifying member for retention within the sheath; and
b. an attachment surface, the attachment surface operably configured to associate the retainer with the second surface of the portable device, wherein the attachment surface is detachable from the second surface of the portable device such that the retainer may be removed.
